(19) United States
(12) Patent Application Publication
(10) Pub. No.: US 2026/0266950 A1
(43) Pub. Date: Sep. 10, 2026

(54) Methods and Apparatus of Managing Communication Resources of a Wireless Communication Network for Radar Use

(71) Applicant: Telefonaktiebolaget LM Ericsson (publ), Stockholm (SE)

(72) Inventors: Ashkan Kalantari, Malmö (SE); Henrik Sjöland, Lund (SE); Andres Reial, Höllviken (SE); Fredrik Dahlgren, Lund (SE); Magnus Sandgren, Staffanstorp (SE); Ricardo Blasco Serrano, Espoo (FI); Gang Zou, Lund (SE)

(21) Appl. No.: 19/099,490

(22) PCT Filed: Aug. 1, 2022
(86) PCT No.: PCT/EP2022/071523

§ 371 Date: Jan. 29, 2025

(51) Int. Cl. G01S 7/00; G01S 13/86; H04B 7/06

(52) U.S. Cl. CPC G01S 7/006; G01S 13/86; H04B 7/0617

(57) ABSTRACT

Disclosed methods and apparatuses embody one or more techniques whereby User Equipments (UEs) receive and follow directionally relevant restrictions on usage of communication resources of the network for radar sensing. In an example embodiment, one or more radio network nodes each transmits restriction signaling for associated beam coverage areas. In complementary fashion, in response to a UE receiving restriction signaling incoming to the UE via a particular reception direction, the UE observes the indicated restrictions on usage of communication resources for radar transmissions in a direction reciprocal to the reception direction. In at least one embodiment, System Information Blocks (SIBs) transmitted for the respective beam coverage areas convey corresponding restriction signaling. The beam coverage areas may be associated with synchronization beams transmitted by the radio network nodes and the network may allocate communication resources for radar sensing use on a per beam coverage area basis and perform dynamic reallocations.

### TECHNICAL FIELD

Disclosed embodiments relate to wireless communication networks and the use of communication resources of such networks for radar sensing by User Equipments (UEs).

### BACKGROUND

A “User Equipment” or “UE” is a device or apparatus configured to use a communication network, such as a wireless telecommunications network based on Third Generation Partnership Project (3GPP) specifications. Using a communication network means wirelessly connecting to the network to gain access to one or more communication services. Reference to “user” implies end equipment rather than network infrastructure and subscription or prepaid agreements may be required for UEs to make use of a given communication network. A UE may be a standalone device, e.g., a personal communication device, or may be embedded in or associated with another device or system. For example, automobiles or other types of vehicles may embed one or more UEs for communications, such as for Vehicle-to-Vehicle (V2V) or Vehicle-to-Everything (V2X) communications.

As communication signal frequencies increase and UEs include transceiver circuitry adapted for such frequencies, it becomes increasingly practical to incorporate radar sensing capabilities into UEs. As used herein, “radar sensing” by a UE refers to the transmission of a signal by the UE and associated sensing by the UE of return reflections, e.g., for detecting proximate obstructions or other environmental sensing, such as rain detection. At least some of the same UE circuitry used for the transmission and reception of high-frequency communication signals, e.g., Gigahertz signals, may be reused for radar sensing.

A UE designed to perform radar sensing may be referred to as a radar enabled UE, a UE with radar capability, or simply as a radar UE. However, for brevity, any reference to UEs herein may be understood as referencing radar UEs unless otherwise stated or clear from the context.

Where distinctions are helpful, a UE that does not or cannot perform radar sensing may be referred to as a legacy UE, a non-radar UE, or a communications-only UE.

Because of the heavy demand for communication services of various types, the communication resources of a communication network are in high demand. “Communication resources” include any one or more of frequency resources, temporal resources, code resources, and spatial resources. As an example, the communication carriers used in a wireless communication network for downlink and uplink transmissions may be shared among multiple UEs (users) by allocating different subcarriers or frequency channels at different times to different users, essentially representing the carrier as a time-frequency grid, wherein each subcarrier or frequency channel taken at a particular time instant represents a distinct allocable communication resource. Resources have a spatial dimension in the sense that with directional transmission or reception, the same frequencies and/or times may be reused for multiple users in different directions.

One aspect of managing UEs that perform radar sensing involves the allocation of communication resources for use by UEs in performing radar sensing. However, significant challenges arise, not only because the reuse of communication resources for radar sensing represents additional competition for limited resources, but also because the use of communication resources for radar sensing introduces interference risks, between UEs performing radar sensing and between UEs performing radar sensing and UEs engaged in network communications. For example, permitting the use of selected uplink resources for radar sensing means that UEs using those resources for radar sensing within a given coverage area of the network are potential uplink interferers with respect to use of those same resources for communications in a neighboring area of the network. Further potential problems include the introduction of signaling burdens arising from the mechanisms used by the network to manage reuse of communication resources for radar sensing and to indicate the resource allocations for radar sensing.

### SUMMARY

Disclosed methods and apparatuses embody one or more techniques whereby User Equipments (UEs) receive and follow directionally relevant restrictions on usage of communication resources of the network for radar sensing. In an example embodiment, one or more radio network nodes each transmits restriction signaling for associated beam coverage areas. In complementary fashion, in response to a UE receiving restriction signaling incoming to the UE via a particular reception direction, the UE observes the indicated restrictions on usage of communication resources for radar transmissions in a direction reciprocal to the reception direction. In at least one embodiment, System Information Blocks (SIBs) transmitted for the respective beam coverage areas convey corresponding restriction signaling. The beam coverage areas may be associated with synchronization beams transmitted by the radio network nodes and the network may allocate communication resources for radar sensing use on a per beam coverage area basis and perform dynamic reallocations.

An example embodiment comprises a method of operation by a UE configured for operation with a wireless communication network. The method includes the UE: directionally listening for restriction signaling, wherein each of one or more radio network nodes transmits restriction signaling in a corresponding transmit beam direction for each of one or more beam coverage areas associated with the radio network node, and wherein the restriction signaling transmitted for each beam coverage area indicates which communication resources of the wireless communication network are allowed for radar sensing use by UEs with respect to the beam coverage area; receiving restriction signaling in a particular listening direction, the received restriction signaling transmitted by a particular radio network node for a particular beam coverage area; and complying with the received restriction signaling with respect to radar sensing by the UE in a transmission direction reciprocal to the particular listening direction.

A related embodiment comprises a UE configured for operation with a wireless communication network. The UE includes communication interface circuitry and processing circuitry. The processing circuitry is configured to: directionally listen, for restriction signaling via the communication interface circuitry, wherein each of one or more radio network nodes transmits restriction signaling in a corresponding transmit beam direction for each of one or more beam coverage areas associated with the radio network node, and wherein the restriction signaling transmitted for each beam coverage area indicates which communication resources of the wireless communication network are allowed for radar sensing use by UEs with respect to the beam coverage area; receive restriction signaling in a particular listening direction, the received restriction signaling transmitted by a particular radio network node for a particular beam coverage area; and comply with the received restriction signaling with respect to radar sensing by the UE in a transmission direction reciprocal to the particular listening direction.

Another embodiment comprises a method of operation by a radio network node of a wireless communication network. The method includes: generating restriction signaling for each of one or more beam coverage areas associated with the radio network node, the restriction signaling corresponding to each beam coverage area indicating which communication resources of the wireless communication network are allowed for radar sensing use by UEs with respect to the beam coverage area; and transmitting the restriction signaling for each beam coverage area via a transmit beam corresponding to the beam coverage area. Note that signaling sent for a given beam coverage area may also indicate restrictions for one or more other beam coverage areas.

A related embodiment comprises a radio network node configured for operation in a wireless communication network. The radio network node includes communication interface circuitry and processing circuitry, where the processing circuitry is configured to: generate restriction signaling for each of one or more beam coverage areas associated with the radio network node, the restriction signaling corresponding to each beam coverage area indicating which communication resources of the wireless communication network are allowed for radar sensing use by UEs with respect to the beam coverage area; and transmit, via the communication interface circuitry, the restriction signaling for each beam coverage area via a transmit beam corresponding to the beam coverage area.

### BRIEF DESCRIPTION OF THE DRAWINGS

FIG. 1 is a block diagram of one embodiment of a wireless communication network.

FIG. 2 is a diagram of example allocations of communication resources for radar usage, on a per beam basis.

FIG. 3 is a diagram of an example transmit beam and corresponding beam coverage area and associated restriction signaling.

FIGS. 4 and 5 are block diagrams of a User Equipment (UE), according to an example embodiment.

FIG. 6 is a logic flow diagram of a method of operation by a UE, according to an example embodiment.

FIG. 7 is a logic flow diagram of a method of operation by a radio network node, according to an example embodiment.

FIG. 8 is a block diagram of a radio network node and a UE, according to respective example embodiments.

FIG. 9 is a block diagram of an example implementation of processing circuitry of a UE, according to an example embodiment.

FIG. 10 is a block diagram of a UE, according to an example embodiment.

FIG. 11 is a block diagram of an example implementation of processing circuitry of a radio network node, according to an example embodiment.

FIGS. 12 and 13 are block diagrams of a radio network node, according to respective example embodiments.

FIGS. 14A and 14B are a logic flow diagram of a method of operation by a wireless communication network and a UE, according to an example embodiment.

### DETAILED DESCRIPTION

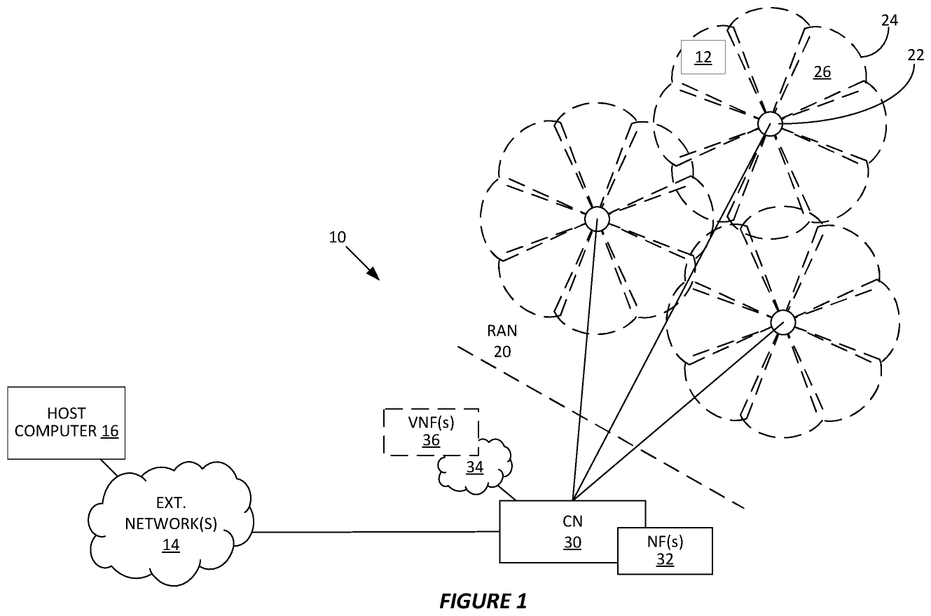

FIG. 1 illustrates a wireless communication network 10 according to one embodiment. As an example, the network 10 is a cellular communication network operating according to Third Generation Partnership Project (3GPP) specifications, such as the Fifth Generation (5G)/New Radio (NR) specifications.

One User Equipment (UE) 12 appears for simplicity of illustration, but the network 10 may support many UEs 12 at the same time, over one or more network coverage areas, with the UEs 12 being of uniform or divergent types. Unless noted, references to a UE 12 or UEs 12 presume that the UE(s) in question are radar UEs, meaning that they perform radar sensing or are otherwise designed for and capable of performing radar sensing.

The network 10 provides one or more communication services, such as broadband mobile media services, Machine Type Communication (MTC) services, etc. One aspect of providing such services is communicatively coupling UEs 12 to other devices or systems, such that the network 10 operating as an access network communicatively couples respective UEs 12 to one or more external networks 14. Example external networks 14 include the Internet or other packet data networks, and such networks may provide connectivity with other systems and equipment, such as various host computers 16 providing data services, communication services, custom applications, etc.

A Radio Access Network (RAN) 20 of the network 10 provides the air interface(s) used to couple respective UEs 12 to the network 10 via wireless signaling. The air interface(s) comprise one or more carriers in one or more frequency bands, supporting downlink communications from the network 10 to respective UEs 12 and uplink communications from the respective UEs 12 to the network 10. The carriers may be shared for serving multiple UEs 12 based on a repeating frame/subframe/slot structure, whereby specific frequencies at specific times are allocable for control signaling or data for respective UEs 12. Elements of the RAN 20 include one or more radio network nodes 22, which are commonly referred to as access points, base stations, transmission reception points, etc. In a 5G context, the radio network nodes 22 are referred to as “gNBs”.

Beamforming by the respective radio network nodes 22 provides signal gain by focusing radio transmissions directionally, with FIG. 1 depicting a non-limiting example of beamforming by the radio network nodes 22. Each radio network node 22 transmits one or more beams 24, with each transmit beam 24 having a corresponding beam coverage area 26. Adjacent beam coverage areas 26 associated with the same radio network node 22 may be at least partially overlapping and transmit beams 24 from respective radio network nodes 22 may have at least partially overlapping beam coverage areas 26, e.g., for continuity of network coverage for UEs 12 moving within the overall coverage area of the RAN 20.

While FIG. 1 emphasizes transmit beamforming by the radio network nodes 22, one or more of the radio network nodes 22 may perform reception beamforming, meaning that the node uses analog and/or digital techniques to enhance its reception sensitivity in particular directions, as compared to wide-area or omnidirectional reception. One approach to transmit beamforming has each radio network node 22 transmitting synchronization signals on a per transmit beam basis, e.g., by performing periodic beam sweeps in which each node transmits a synchronization signal in each beam direction among a plurality of beam directions. Transmitting one or fewer than all beams at a time has the advantage of requiring less total transmit power than would be needed to achieve the same per beam power levels during simultaneous transmission of all beams.

In a particular example, each radio network node 22 transmits Synchronization Signal Blocks (SSBs) on a per beam basis, with these SSBs allowing UEs 12 to perform cell discovery, identification, and synchronization. A SSB includes, for example, a Physical Broadcast Channel (PBCH) that carries certain information needed to access the “cell”, along with including a Primary Synchronization Signal (PSS) used for initial or rough synchronization and a Secondary Synchronization Signal (SSS) for cell timing synchronization.

Here, “cell” broadly refers to the association of particular communication resources from a particular radio network node 22, for providing network coverage in a corresponding region or area. The respective beam coverage areas 26 associated with a given radio network node 22 can be understood as being sectors or regions of the overall cell provided by the given radio network node 22 or may be regarded as each corresponding to a different cell.

In at least one arrangement, the respective transmit beams 24 transmitted by a radio network node 22 are differentiated in terms of beam identity (ID) or beam index, with all such transmit beams 24 being commonly associated with the cell ID of the radio network node 22 transmitting them. Each transmit beam 24 can be understood as a directionally oriented radio signal transmission carrying given information, with each transmit beam 24 having an associated transmit beam direction, shape, and coverage area. In embodiments where the transmit beams 24 in question carry synchronization signals, they may be referred to as synchronization beams.

Where the respective transmit beams 24 are SSB beams, the corresponding beam coverage areas 26 are SSB areas. In at least one embodiment, each radio network node 22 transmits a number of SSB beams on a periodic basis, each SSB illuminating a corresponding SSB area, meaning that UEs 12 can listen for SSB transmission, for cell synchronization and other purposes.

Downlink and uplink communications between the radio network nodes 22 and respective UEs 12 use communication resources, such as any one or more of time resources, frequency resources, code resources, and spatial resources. “Spatial” resources refer to the ability to reuse the same frequency, time, code, or other such resource in different network coverage areas, e.g., in different beam coverage areas 26. The network 10 in one or more embodiments allocates communication resources for radar use, with such allocations managed on a per beam coverage area basis. That is, a certain fraction or portion of the overall communication resources used by the network 10 in each beam coverage area 26 is set aside for radar sensing by UEs 12 rather than for communications. For example, certain time-frequency resources in each beam coverage area 26 are allowed for use in radar sensing rather than communication-signal transmission/reception. As noted, “radar sensing” refers to any given UE 12 transmitting a signal for object detection or environmental sensing, rather than for conventional communications, with the UE 12 performing radar processing on return reflections of the transmitted signal.

The particular communication resources set aside in each beam coverage area 26 may be referred to as radar resources and the radio network nodes 22 may decide and manage these radar allocations individually or on a cooperative basis, or another node in the network 10 may decide and manage the radar allocations based on having a centralized view of communication and radar needs within the overall coverage area of the RAN 20 or any given radio network node 22. For example, a Core Network (CN) node in a CN 30 of the network 10 may decide or otherwise assist with deciding the radar allocations, and such allocations may be dynamic during operation of the network 10.

Although shown in simplified form, the CN 30 shall be understood as comprising a number of network nodes, e.g., computer servers and supporting routers, switches, or bridges, with the CN 30 defined in terms of the Network Functions (NFs) 32 implemented within it. In a 5G context, NFs 32 include User Plane Functions (UPFs), Session Management Functions (SMFs), Access and Mobility Management Functions (AMFs), etc. Each such NF 32 may be understood as specific processing logic or functionality instantiated in corresponding processing circuitry. One or more of the NFs 32 and, in some embodiments, at least some of the processing and control functionality of the radio network nodes 22, may be implemented via a cloud 34 instantiating Virtualized NFs (VNFs) 36. It will be appreciated that VNFs 36 are instantiated on underlying physical circuitry and are, therefore, tangible processing logic.

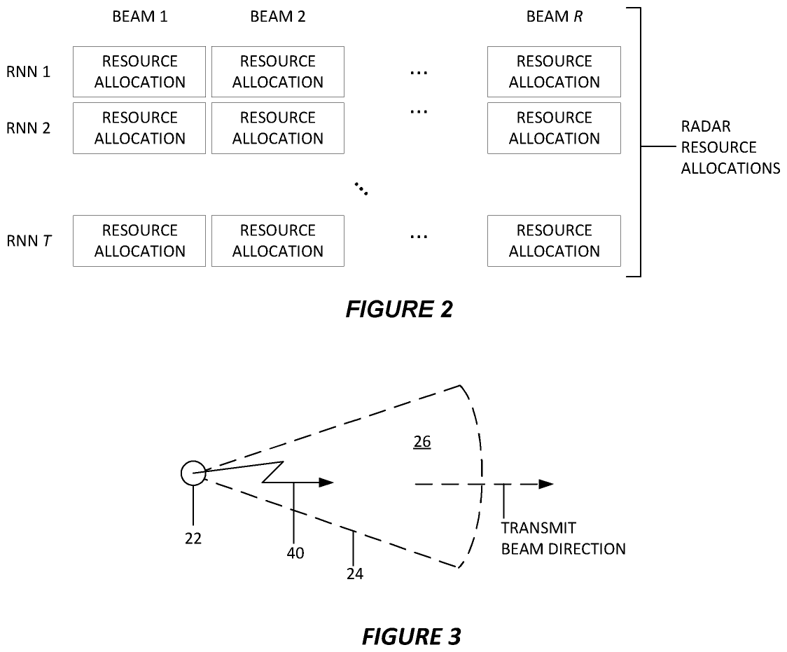

FIG. 2 illustrates example radar allocations. Each radio network node 22—“RNN” in the diagram—allocates particular communication resources for radar usage in each beam coverage area 26 associated with the radio network node 22. In the diagram, “BEAM 1”, “BEAM 2”, and so on denote the respective beam coverage areas 26 associated with each radio network node 22.

FIG. 3 illustrates that each radio network node 22 transmits restriction signaling 40 in each transmit beam 24. The restriction signaling 40 indicates the radar allocation for the corresponding beam coverage area 26. The indication may be direct, where the restriction signaling 40 identifies the communication resources that are allowed for radar sensing within the corresponding beam coverage area 26, or it may be indirect, where the restriction signaling 40 indicates communication resources that are disallowed for such use. In one or more embodiments, each radio network node 22 transmits SSBs for each transmit beam 24 among a plurality of transmit beams 24, with the aggregation of the corresponding beam coverage areas 26 representing an overall coverage area of the radio network node 22.

In at least one embodiment, the restriction signaling 40 transmitted by a radio network node 22 in each beam coverage area 26 associated with the radio network node 22 identifies all associated beam coverage areas 26 and the restrictions for each such area. In other embodiments, the restriction signaling 40 transmitted for each associated beam coverage area 26 carries the restriction information for that area and for the neighboring beam coverage areas 26. One beam coverage area 26 neighbors another beam coverage area 26 if it overlaps the other beam coverage area 26, meaning that the restriction signaling 40 transmitted by a radio network node 22 for a given one of its associated beam coverage areas 26 indicates the restriction signaling applicable to that area and may indicate the restrictions applicable to least the neighboring ones among the other beam coverage areas 26 associated with the radio network node 22.

In at least one embodiment, the transmit beams 24 are synchronization beams, e.g., SSB transmissions, and the beam coverage areas 26 are SSB areas. The SSBs transmitted via each transmit beam 24 carry a broadcast channel and one or more synchronization signals, e.g., each SSB carries a PBCH, a PSS, and a SSS. A Master Information Block (MIB) conveyed via the broadcast channel contains information regarding the location—e.g., in terms of time/frequency resources—of a System Information Block (SIB) that carries restriction signaling 40 indicating radar allocation information. In other words, the SSB transmitted by a radio network node 22 for each SSB area that is associated with the radio network node 22 may carry information indicating the time-frequency resources that are used by the radio network node 22 for transmitting a radar SIB for the SSB area.

Alternatively, the SIB1 transmitted by the radio network node 22 for each SSB area carries the information identifying the time/frequency location of the radar SIB transmitted for the SSB area. In 5G, UEs perform initial synchronization with the network using the PSS/SSS transmission and read the MIB from the PBCH, with the UEs then using information conveyed in the MIB to read the corresponding SIB1. In any case, it will be understood that in one or more embodiments, each radio network node 22 transmits an SSB in each SSB direction among a plurality of SSB directions that collectively represent the cell or aggregate coverage provided by the radio network node 22, with the radio network node 22 further transmitting a radar SIB in each SSB direction that indicates the radar allocation for at least that SSB direction.

Thus, a UE 12 that successfully receives a SSB corresponding to a particular beam coverage area 26 learns how to receive the radar SIB transmitted for that beam coverage area 26. In turn, the radar SIB allows the UE 12 to determine which communication resources of the network 10 are allowed for radar sensing within that beam coverage area 26, and the radar SIB may further indicate the radar allocations for one or more further beam coverage areas 26 associated with the transmitting radio network node 22. Whether any given UE 12 detects the SSB for a given beam coverage area 26 depends on numerous variables, including the location of the UE 12 in relation to the location of the involved radio network node 22 and the transmit direction of the transmit beam 24 that conveys the SSB. Here, the “transmit direction” of the transmit beam 24 may be defined in terms of horizontal and vertical angles.

In one or more embodiments, a UE 12 directionally listens for restriction signaling 40 and, with respect to restriction signaling 40 received in a particular listening direction, the UE 12 complies with the signaled restrictions for radar sensing in the reciprocal direction. In at least one embodiment, the UE 12 uses directional reception to listen for beam-specific reference signals, e.g., SSBs transmitted in respective transmit beams 24 from one or more radio network nodes 22. To the extent that the UE 12 detects reference signals for a given listening direction at or above some defined received-signal threshold, the UE 12 determines the radar resource restrictions associated with the detected reference signals and observes those restrictions for radar sensing in a transmit direction reciprocal to the given listening direction.

Such operations can be understood as the UE 12 advantageously determining which reference signals it “hears” in a given listening direction at a sufficient signal level and then, based on the underlying principle of signal reciprocity, avoiding causing radar interference to network communications by not transmitting radar signals in a transmit direction reciprocal to the listening direction on any communication resources that are not reserved for radar use in the beam coverage areas 26 associated with the reference signals heard by the UE. The received-signal threshold may be that associated with detectability—i.e., a received-signal strength sufficient for the UE 12 to discern and process the reference signal.

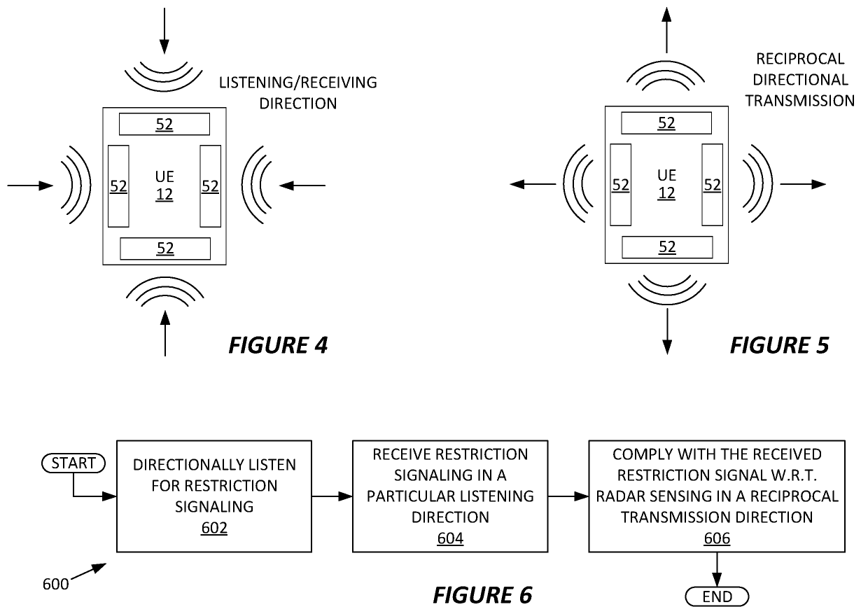

FIGS. 4 and 5 illustrate an example embodiment, wherein a UE 12 includes multiple antenna assemblies 52, each having an associated directionality. For a given orientation of the UE 12, each antenna assembly 52 “points” or faces in a respective direction and is most sensitive to radio signals incoming along the facing direction. Each antenna assembly 52 comprises, for example, an antenna panel comprising a plurality of antenna elements, each associated with a respective transmit and/or receive signal chain. In at least one embodiment, the UE 12 is configured to perform transmit and/or receive beamforming on a per antenna assembly basis. Further, in at least one embodiment, the communication resources used or avoided by the UE 12 with respect to radar transmissions from any particular one of the antenna assemblies 52 depends on which beam-based reference signals the UE 12 detects via the antenna assembly 52, and the restriction signaling 40 received for the beam coverage areas 26 corresponding to the detected reference signals.

FIG. 6 illustrates a method 600 of operation by a UE 12, according to one embodiment. Although the method 600 is depicted with a start and end, it shall be understood that the method 600 may be looped or otherwise repeated as an ongoing process carried on by the UE 12.

The method 600 includes: directionally listening (Block 602) for restriction signaling 40, wherein each of one or more radio network nodes 22 transmits restriction signaling 40 in a corresponding transmit beam direction for each of one or more beam coverage areas 26 associated with the radio network node 22, and wherein the restriction signaling 40 transmitted for each beam coverage area 26 indicates which communication resources of the wireless communication network are allowed for radar sensing use by UEs 12 with respect to the beam coverage area 26; receiving (Block 604) restriction signaling 40 in a particular listening direction, the received restriction signaling 40 transmitted by a particular radio network node 22 for a particular beam coverage area 26; and complying (Block 606) with the received restriction signaling 40 with respect to radar sensing by the UE 12 in a transmission direction reciprocal to the particular listening direction.

In one or more embodiments, for each beam coverage area 26, the associated radio network node 22 transmits a SIB that conveys the restriction signaling 40. Here, the receiving step comprises the UE 12 receiving and successfully decoding the SIB transmitted by the particular radio network node 22 for the particular beam coverage area 26. The particular listening direction is defined by a directional reception sensitivity of the UE 12 arising from reception beamforming by the UE 12, in one or more embodiments. In at least one embodiment, the UE 12 has multiple antenna assemblies 52, each having a corresponding directionality relative to a current orientation of the UE 12, and wherein the particular listening direction is defined by the particular antenna assembly 52 associated with the received restriction signaling 40.

The communication resources at issue may comprise resource elements or groups of resource elements defined by a time-frequency grid according to which uplink and downlink transmissions in the network 10 are scheduled. Regardless of the specific nature of the communication resources at issue, in one or more embodiments, complying with the received restriction signaling 40 comprises selecting only allowed communication resources for radar sensing by the UE 12 in the reciprocal transmission direction.

The restriction signaling 40 transmitted for each beam coverage area 26 in one or more embodiments includes first restriction signaling indicating the allowed communication resources for the beam coverage area 26, and further includes second restriction signaling indicating the allowed communication resources for each of one or more neighboring beam coverage areas 26. Correspondingly, the method 600 further comprises the UE 12 deciding whether to comply with the second restriction signaling received for each neighboring beam coverage area 26, in dependence on whether, with respect to the particular listening direction, the UE 12 receives a SSB or other reference signal transmission for the neighboring beam coverage area 26 at or above a threshold received signal level.

The received restriction signaling 40 in one or more embodiments comprises a SIB that is received and successfully decoded by the UE 12, with the SIB transmitted by the particular radio network node 22 for the particular beam coverage area 26. The SIB in one or more embodiments indicates further restriction information for each of one or more beam coverage areas 26 neighboring the particular beam coverage area 26, and the method 600 further comprises, with respect to the reciprocal transmission direction, the UE 12 complying with the further restrictions for each such neighboring beam coverage area 26 in dependence on whether, with respect to the particular listening direction, the UE 12 receives a reference signal transmitted for the neighboring beam coverage area 26 at or above a threshold received signal level.

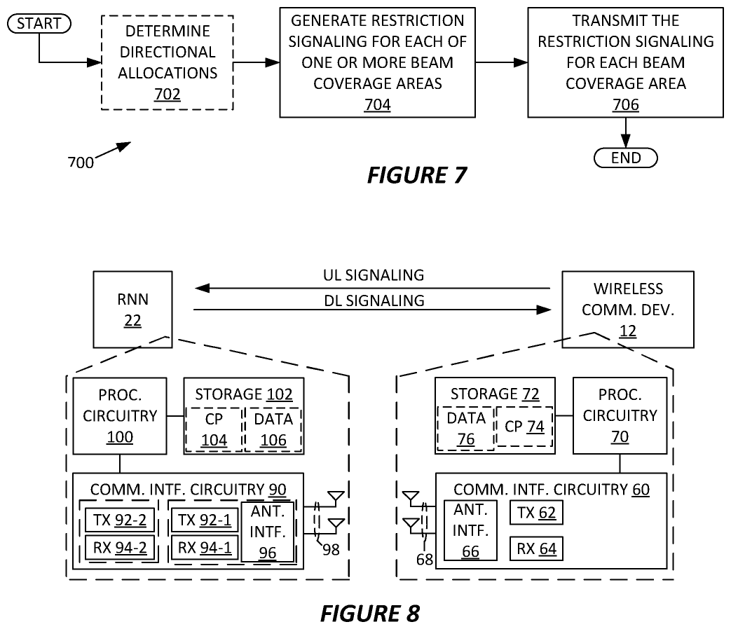

FIG. 7 illustrates a method 700 of operation by a radio network node 22 of a wireless communication network 10. Although the method 700 is depicted with a start and end, it shall be understood that the method 700 may be looped or otherwise repeated as an ongoing process carried on by the radio network node 22.

The method 700 includes: generating (Block 704) restriction signaling 40 for each of one or more beam coverage areas 26 associated with the radio network node 22, the restriction signaling 40 corresponding to each beam coverage area 26 indicating which communication resources of the wireless communication network are allowed for radar sensing use by UEs 12 with respect to the beam coverage area 26; and transmitting (Block 706) the restriction signaling 40 for each beam coverage area 26 via a transmit beam 24 corresponding to the beam coverage area 26.

Note that one or more steps of the method 700 may involve periodic or recurring operations, such as where each radio network node 22 periodically transmits synchronization signals and restriction signaling 40 for respective beam coverage areas 26 associated with the radio network node 22. Further, the method 700 in one or more embodiments includes determining directional allocations (Block 702)—i.e., determining which ones among the overall communication resources of the network 10 are allocated for radar sensing use, in each of the respective beam coverage areas 26 associated with each respective radio network node 22. Consequently, at least Blocks 704 and 706 of the method 700 may be understood as operations performed by each radio network node 22 with respect to each beam coverage area 26 associated with the node. Determining the directional allocations (Block 702) may be performed independently by each radio network node 22 or cooperatively based on coordination among respective radio network nodes 22, or performed by a centralized entity within the network 10, and the determinations may include an initial determination, e.g., default allocations, and also ongoing, dynamic determinations on a periodic or triggered basis, in dependence on the communications and radar-sensing needs estimated for the respective beam coverage areas 26.

The step in the method 700 of transmitting the restriction signaling 40 for each beam coverage area 26 may, as noted, comprise repeatedly transmitting the restriction signaling 40 for each one of the one or more beam coverage areas 26.

The one or more beam coverage areas 26 comprises, for example, a plurality of beam coverage areas 26 illuminated by the radio network node 22 via transmit-beam sweeping. In one or more such embodiments, the step of repeatedly transmitting the restriction signaling 40 for each beam coverage area 26 comprises the radio network node 22 transmitting the restriction signaling 40 for each beam coverage area 26 in each beam sweep.

The step of generating the restriction signaling 40 comprises, with respect to a particular instance of transmitting the restriction signaling 40 for a particular one of the one or more beam coverage areas 26, generating the restriction signaling 40 based on a resource allocation corresponding to the particular beam coverage area 26. The method 700 may further comprise dynamically updating the resource allocations for at least one of the one or more beam coverage areas 26, in dependence on actual or estimated radar-sensing needs by UEs 12 in the at least one beam coverage area 26. The restriction signaling 40 transmitted at any given time for any given beam coverage area 26 reflects the then-current resource allocation applicable to that beam coverage area 26. In one or more embodiments, the method 700 further includes determining the actual or estimated radar-sensing needs by UEs 12 in the at least one beam coverage area 26 in dependence on the number of UEs 12 in each such beam coverage area 26 that are performing radar sensing or have indicated radar sensing capability. As noted, the method 700 may include initializing the resource allocation for each of the one or more beam coverage areas 26 according to a default allocation scheme.

In at least one embodiment, the step of transmitting the restriction signaling 40 for each beam coverage area 26 comprises transmitting, for each beam coverage area 26, a corresponding SIB that includes the restriction signaling 40. The restriction signaling 40 included in each SIB comprises, for example, first restriction signaling applicable to the corresponding beam coverage area 26, and second restriction information for each of one or more neighboring beam coverage areas 26. In other words, the restriction signaling 40 carried in a transmit beam 24 corresponding to a particular beam coverage area 26 carries restrictions applicable to the particular beam coverage area 26 and may carry restrictions applicable to one or more neighboring beam coverage areas 26. In at least one embodiment, a UE 12 receiving such a SIB along a particular listing direction follows the signal restrictions for the neighboring beam coverage areas 26 in dependence on whether, in that same listening direction, the UE 12 detects reference signals transmitted for those neighboring beam coverage areas 26 at or above some defined received-signal strength threshold.

The method 700 according to one or more embodiments, further comprises each radio network node 22 transmitting a SSB for each beam coverage area 26, wherein the SSB for each beam coverage area 26 indicates a beam index corresponding to the beam coverage area 26 and indicates at least one further beam index corresponding to at least one neighboring beam coverage area 26. Referring to each radio network node 22 as transmitting a SSB for each of the beam coverage areas associated with the node can be understood as encompassing periodic or repeating transmissions of SSBs for each such area.

FIG. 8 illustrates example details for a radio network node 22 and a UE 12, according to example embodiments. The illustrated UE 12 is labeled as a “wireless communication device”. The UE 12 includes communication interface circuitry 60 and processing circuitry 70. The communication interface circuitry 60 includes physical-layer circuitry—one or more radio transmitters 62 and receivers 64—configured for transmitting and receiving radio signals in accordance with the specifications and requirements of the network 10. For example, the transmitter(s) 62 and receiver(s) 64 couple to one or more antennas 68 via antenna interface circuitry 66. Here, the one or more antennas 68 comprise, for example, one or more antenna assemblies 52 as shown in FIGS. 4 and 5, for example, or other antenna arrangements.

The communication interface circuitry 60 may further comprise timing and protocol-processing circuitry, or such operations may be performed by the processing circuitry 60. In at least one embodiment, the communication interface circuitry 60 comprises mixed-signal circuitry including both analog radio circuitry and baseband digital processing circuitry for data transmission and reception, e.g., a cellular radio modem.

The communication interface circuitry 60 and/or the processing circuitry 70 is/are configured to perform beamforming in one or more embodiments, such as by using an array of antenna elements to perform reception beamforming in one or more reception beam directions. Beamforming may be performed in the analog domain, the digital domain, or as a hybrid involving both domains. However, regardless of whether reception beamforming is used, in at least one embodiment, the UE 12 accomplishes directional listing by virtue of using respective antenna assemblies 52 that face or point in different directions for a given orientation of the UE 12.

The processing circuitry 70 is operatively associated with the communication interface circuitry 60, meaning that it transmits data and control signaling via the communication interface circuitry 60 and, likewise, receives data and control signaling via the communication interface circuitry 60. The processing circuity 70 comprises fixed circuitry or programmatically configured circuitry or a mix of both. The processing circuitry 70 is configured to perform any or all the operations embodied in the method 600, or generally any of the operations described herein for a UE 12.

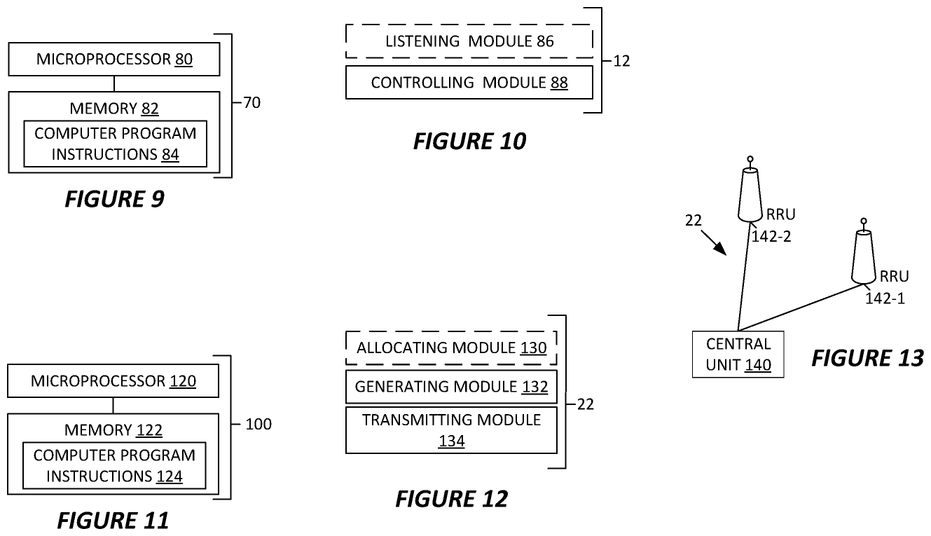

The processing circuitry 70 in one or more embodiments includes or is associated with storage 72, which comprises one or more types of computer readable media for at least temporarily storing one or more computer programs 74 and one or more items of configuration data or operating data 76. For example, in at least one embodiment, as shown in FIG. 9, the processing circuitry 70 comprises one or more microprocessors 80 and associated memory 82 storing computer program instructions 84, that, when executed by the one or more microprocessors 80, specially adapt those microprocessors 80 to operate as the processing circuitry 70—i.e., to perform the UE-side operations described herein. The memory 82 comprises all or a portion of the storage 72, which may include both volatile storage and non-volatile storage, such as a mix of RAM and FLASH.

Thus, however implemented, the processing circuitry 70 is configured to: directionally listen, for restriction signaling 40 via the communication interface circuitry 60, wherein each of one or more radio network nodes 22 transmits restriction signaling 40 in a corresponding transmit beam direction for each of one or more beam coverage areas 26 associated with the radio network node 22, and wherein the restriction signaling 40 transmitted for each beam coverage area 26 indicates which communication resources of the wireless communication network are allowed for radar sensing use by UEs 12 with respect to the beam coverage area 26; receive restriction signaling 40 in a particular listening direction, the received restriction signaling 40 transmitted by a particular radio network node 22 for a particular beam coverage area 26; and comply with the received restriction signaling 40 with respect to radar sensing by the UE 12 in a transmission direction reciprocal to the particular listening direction.

FIG. 10 illustrates another example embodiment of UE 12, wherein the UE 12 is implemented as processing units or modules, where at least a portion of such modules may be instantiated in a virtualization environment. That is, the modules may be realized as virtual functions instantiated via underlying physical circuitry.

Such modules include a listening module 86 that is configured to directionally listen for restriction signaling 40, wherein each of one or more radio network nodes 22 transmits restriction signaling 40 in a corresponding transmit beam direction for each of one or more beam coverage areas 26 associated with the radio network node 22, and wherein the restriction signaling 40 transmitted for each beam coverage area 26 indicates which communication resources of the wireless communication network are allowed for radar sensing use by UEs 12 with respect to the beam coverage area 26. A controlling module 88 of the UE 12 is configured to receive restriction signaling 40 in a particular listening direction, the received restriction signaling 40 transmitted by a particular radio network node 22 for a particular beam coverage area 26 and comply with the received restriction signaling 40 with respect to radar sensing by the UE 12 in a transmission direction reciprocal to the particular listening direction. Here, complying means controlling radar sensing by the UE 12 with respect to the reciprocal transmission direction, in observance of the signaled restrictions—i.e., use or avoid using certain communication resources when performing radar sensing in the reciprocal transmission direction.

Turning back to FIG. 8, the example radio network node 22 is configured for operation in a network and includes communication interface circuitry 90 and processing circuitry 100. The communication interface circuitry 90 includes physical-layer circuitry—one or more transmitters 92 and receivers 94. For example, one or more first transmitters 92-1 and one or more first receivers 94-1 are radio transmitters and receivers that are configured to provide the air interface used to communicate with UEs 12—i.e., cellular radio transmitters and receivers for performing downlink transmissions and uplink receptions according to the air interface specifications. Such circuitry couples to one or more antennas 98 via antenna interface circuitry 96. Here, the one or more antennas 98 comprise, for example, one or more antenna arrays comprising pluralities of antenna elements for transmission beamforming and, in one or more embodiments, reception beamforming. Beamforming may be performed in the analog domain, the digital domain, or as a hybrid involving both domains, to form transmit beams 24 at each radio network node 22, corresponding to beam coverage areas 26 associated with each radio network node 22.

One or more second transmitters 92-2 and one or more receivers 94-2 comprised in the communication interface circuitry 90 are used to couple the radio network node 22 to other entities within the network 10, e.g., to neighboring radio network nodes 22, NFs 32 in the CN 30, etc. Examples of such circuitry include Ethernet interface circuitry or other data-networking interfaces.

The processing circuitry 100 is operatively associated with the communication interface circuitry 90, meaning that it transmits data and control signaling via the communication interface circuitry 90 and, likewise, receives data and control signaling via the communication interface circuitry 90. The processing circuity 100 comprises fixed circuitry or programmatically configured circuitry or a mix of both. The processing circuitry 100 is configured to perform any or all the operations embodied in the method 700 or, generally, any of the operations described herein for a radio network node 22.

The processing circuitry 100 in one or more embodiments includes or is associated with storage 102, which comprises one or more types of computer readable media for at least temporarily storing one or more computer programs 104 and one or more items of configuration data or operating data 106. For example, in at least one embodiment, as shown in FIG. 11, the processing circuitry 100 comprises one or more microprocessors 120 and associated memory 122 storing computer program instructions 124, that, when executed by the one or more microprocessors 120, specially adapt those microprocessors 120 to operate as the processing circuitry 100—i.e., to perform the radio network node operations described herein. The memory 122 comprises all or a portion of the storage 102, which may include both volatile storage and non-volatile storage, such as a mix of RAM and FLASH.

Thus, however implemented, the processing circuitry 100 is configured to: generate restriction signaling 40 for each of one or more beam coverage areas 26 associated with the radio network node 22, the restriction signaling 40 corresponding to each beam coverage area 26 indicating which communication resources of the wireless communication network 10 are allowed for radar sensing use by UEs 12 with respect to the beam coverage area 26; and transmit, via the communication interface circuitry 90, the restriction signaling 40 for each beam coverage area 26 via a transmit beam 24 corresponding to the beam coverage area 26.

FIG. 12 illustrates another example embodiment of radio network node 22, wherein the radio network node 22 is implemented as processing units or modules, where at least a portion of such modules may be instantiated in a virtualization environment. That is, the modules may be realized as virtual functions instantiated via underlying physical circuitry. The modules include a generating module 132 configured to generate restriction signaling 40 for each of one or more beam coverage areas 26 associated with the radio network node 22, the restriction signaling 40 corresponding to each beam coverage area 26 indicating which communication resources of the wireless communication network 10 are allowed for radar sensing use by UEs 12 with respect to the beam coverage area 26. Further included is a transmitting module 134 configured to transmit the restriction signaling 40 for each beam coverage area 26 via a transmit beam 24 corresponding to the beam coverage area 26. In one or more embodiments, an allocating module 130 determines radar allocations for the respective beam coverage areas 26.

FIG. 13 illustrates additional example details for a radio network node 22 according to one embodiment, wherein the node comprises a central unit 140 and one or more remote radio units (RRUs) 142, with RRU 142-1 and RRU 142-2 shown merely as an example. Each RRU 142 may provide network coverage over a corresponding plurality of beam coverage areas 26 and transmit synchronization signals and restriction signaling 40 for each such beam coverage area 26.

Correspondingly, the central unit 140 is configured to do any one of the following operations, in addition to performing ongoing downlink/uplink communications-signal processing: (1) independently determine or otherwise manage the radar allocations for each beam coverage area 26 associated with each RRU 142 associated with the central unit 140; (2) cooperatively, based on exchanging signaling with one or more other radio network nodes 22, determine or otherwise manage the radar allocations for each beam coverage area 26 associated with each RRU 142 associated with the central unit 140; or receive information indicating the radar allocations applicable to each beam coverage area 26 associated with each RRU 142 associated with the central unit 140. In this latter case, the central unit 140 may report loading on the communication resources within the associated beam coverage areas 26, the number of UEs 12 currently in the associated beam coverage areas 22 that have reported radar capabilities, etc. One result flowing from the above techniques is that radar and 5G communications coexist during uplink/downlink phases of cellular communication, e.g., based on using SIB and random access mechanisms to allocate radar resources and avoid radar and communication interference. We propose UE-autonomous and NW guided algorithms for radar and 5G communication coexistence.

In at least one embodiment, the radar resources allocated to the beam coverage areas 26 are available for UEs 12 that have “radar” subscriptions with an operator of the network 10 or with an operator having business agreements in place with the operator of the network 10. Such UEs 12 read the resource information carried in the SIB(s). The SIB information points to radar transmission resources in different beam coverage areas 26, where the different beam coverage areas 26 may be, as noted, respective SSB areas of the radio network nodes 22. The available resources may be SSB beam-specific, where a SIB associated with a certain SSB can contain SSB-specific resource descriptions. The number of reserved resources can be allocated depending on the number of UEs performing radar sensing or reporting radar sensing capability in the spatial domain, e.g., with respect to the transmit beam directions of the radio network nodes 22, while also considering resources needed for communication. In one or more embodiments, UEs 12 may connect to a radio network node 22 to obtain a decryption key used to encrypt radar resource information, with only subscription authorized UEs 12 given access to the key.

The disclosed operations build on the 3GPP standards and advantageously integrate the radar resource information in a new type of SIB, with the new SIB enabling autonomous selection by UEs 12 of allocated radar resources—i.e., communication resources that have been allocated for radar sensing use, where the allocations are spatial and organized in correspondence with the beam coverage areas 26 associated with respective radio network nodes 22 of the network 10. With the network 10 providing radar resource information in broadcasted SIBs, a UE 12 does not have to connect to the network 10 to request a resource allocation for radar sensing.

A particular advantage of this approach is that an Idle-mode UE 12 need not connect to the network 10 merely to obtain permission to use certain communication resources of the network 12 for radar sensing. Rather, the network 10 uses SIB transmissions to advertise the communication resources allocated for radar sensing relative to each beam coverage area 26 and the UE 12 uses the allocated resources for radar sensing, at least with respect to transmission directions relevant to the allocations. There is no need for the UE 12 to perform beam training or otherwise go through the communication setup procedures associated with connecting to the network 10. A further bonus is that allowing UEs 12 to identify and use radar resources without need for connecting to the network 10 reduces the signaling overhead in the network 10 that would otherwise be needed to support radar operation by the UEs 12.

Using the directionally-specific radar allocations—i.e., radar allocations on a per beam coverage basis—allows UEs 12 to conform their selection of communication resources for radar sensing in a manner that avoids uplink interference to the network 10. In at least one embodiment, the network 10 allocates time/frequency communication resources on a spatial basis, such that particular time/frequency communication resources are allocated for radar sensing use in each of one or more beam coverage areas 26. Even where these spatial allocations overlap with communications use of the resources, the disclosed technique prevents a UE 12 that is performing radar sensing from interfering with other UEs 12 performing radar sensing or carrying out network-based communications.

In terms of “finding” the radar SIB transmitted for a given beam coverage area 26—i.e., the SIB that carries the restriction signaling 40—a UE 12 may receive the needed information in the SSB transmitted for that area, or by other means. For example, the needed information may be carried in Remaining Minimum System Information (RMSI) or in SIB1.

As far as how respective UEs 12 use the radar allocations to perform radar sensing, one approach is a contention-based utilization. That is, in at least one embodiment, the network 10 transmits restriction signaling 40 for each beam coverage area 26, indicating which communication resources are allocated for radar sensing use within the beam coverage area 26. UEs 12 performing radar sensing in directions relevant to a particular beam coverage area 26 may use the allocated resources on a contention basis. Further, in at least one such embodiment, the contention-based usage involves a prioritization scheme.

As one model of priority, for example, the network operator can divide and assign time, frequency, and spatial resources or give priority based on subscription information indicated in the SIB carrying the restriction signaling 40. In addition, or as an alternative, to indicating subscription-level priority, the SIB transmitted for a particular beam coverage area 26 may carry priority information indicating particular UEs 12 or groups of UEs 12, at least with respect to UEs 12 that are known to the associated radio network node 22. In some cases, no priority is indicated or differentiated, in which case each UE 12 may select one of indicated resources randomly for its radar operation. As noted, the SIB is encrypted in one or more embodiments, so that only UEs 12 with active subscriptions for radar operation can read the SIB. Such embodiments represent a significant new revenue opportunity for the network operator.

As an example priority scheme, a UE 12 with a higher level of priority is allowed to select from all reserved resources while a lower priority UE 12 is allowed to select from only a subset of the same resources, or could be assigned to other priority-dependent resources. As such, UEs 12 of the same priority might content with each other for resources allocated for their priority level, but not have to compete with lower-priority UEs 12 for which other resources are allocated. A UE 12 with high priority might also be allowed to use resources with shorter periodicity or higher duty cycle than a lower priority UE 12, e.g., a high priority UE 12 might be allowed to use resources at every periodic occasion of the allocated resources while a lower priority UE 12 might only be allowed to use every second occurrence. Another example is to divide UEs 12 that have radar sensing capability into groups, for example two groups, and let these groups have access to predetermined subsets of resources. The network 10 may use a flag to map the SIB resources to the priority levels of the respective UEs 12. For example, the UEs 12 having radar subscriptions have access to better sensing resources, as compared to UEs 12 lacking such subscriptions.

Another aspect discussed herein is mapping SIB resources to beam directions of the network 10. That is, the allocations of communication resources for radar sensing use may vary in each transmit beam direction of each radio network node 22. For example, with respect to any given radio network node 22, the radar resource allocation provided in one SSB coverage area is different than the radar resource allocation in another SSB direction. The SIB transmitted for each SSB coverage area may carry restriction signaling 40 indicating the radar allocation for that SSB coverage area and for one or more neighboring SSB coverage areas. The particular amount of communication resources allocated to each SSB coverage area, or the particular communication resources, may depend on the density or number of UEs 12 using radar and/or communications within each SSB coverage area.

In one embodiment, each directional SSB transmission by a radio network node 22 has an associated directional SIB transmission, where the SIB carries restriction signaling 40 applicable at least to the corresponding beam coverage area 22. As such, the SIB carrying the restriction signaling 40 may be referred to as a “radar” SIB and it will be understood that the radio network node 22 may transmit multiple SIBs for the SSB coverage area, with different types of information in each SIB. In any case, a UE 12 that receives the radar SIB obtains from it a list of SSB beam indices, where the list indicates permitted (or prohibited) SSB beam directions.

In one embodiment, a UE 12 is configured such that, if it receives a SIB carrying restriction signaling 40 and successfully extracts from the received SIB a list of SSBs and corresponding per-SSB radar resource allocations, then, with respect to radar transmissions in a direction reciprocal to the reception direction associated with the received SIB, the UE 12 follows the restrictions signaled with respect to each SSB for which a corresponding Reference Signal Received Power (RSRP) at the UE 12 is above a threshold.

On the other hand, if the UE 12 does not detect any SSBs in a particular listening direction or does not detect any SSBs above some defined signal threshold or cannot read any SIBs incoming in that listening direction, then the UE 12 may perform radar sensing in the reciprocal transmission direction using communication resources of the network 10 that do not necessarily conform the network-decided radar allocations.

In one or more embodiments, if a network policy (such as may be transmitted from another coverage cell) allows, a UE 12 might use the desired resources for radar sensing. This may require UE reciprocity.

If, for any SSB beam direction, a corresponding transmitted SIB contains the allocated radar resources of the other, nearest or neighbor SSB beam directions, a UE 12 receiving the SIB can use the indicated resources of the currently undetectable SSB beam directions for radar sensing (in the direction of the currently undetectable SSB beam direction). The UE 12 may use the neighboring relation of the SSBs, which may be provided in the SIB, to identify the indexes of undetectable SSBs. Alternatively, a field included in the SIB1 transmitted for each SSB beam direction indicates the neighboring SSBs and the UE 12 compares the currently detected SSBs vs the list to figure out the indexes of the undetectable SSBs. As a variation of this approach, the SIB transmitted in each SSB coverage area to convey the restriction signaling 40 may contain reserved time info only for the current SSB coverage area. Here, “current” refers to the SSB that corresponds with the transmitted SIB. Similarly, for each SSB direction, the SIB may indicate time/frequency resources that are permitted for radar operation, e.g., OFDM symbols, slots, frames, Physical Resource Blocks (PRBs), Bandwidth Parts (BWPs), CORESETS, or other frequency region definitions. Subsets in both time and frequency domains or their combinations may be specified where radar operation is permitted for the given SSB beam, or all beams.

The SSB beam directions may overlap each other to create a good cell coverage, hence, a UE 12 in a certain location may receive and detect multiple SSBs. Because of SSB beam overlap and UE mobility, different neighboring SSBs cannot have independent resource allocation and need to have some common allocated resources. For example, a UE 12 may receive two SSB beams above some defined signal threshold, which, based on the reciprocity principle, indicates that radar sensing by the UE 12 on resources other than those allocated for radio sensing in the two SSB beam areas risks interfering with communication operations at the respective radio network nodes 22 or with other UEs 12 being served by those nodes. More particularly, the UE 12 identifies radar resources that are common to both SSB beam areas and limits its radar sensing to those common resources. On the other hand, a UE 12 that receives only one SSB at or above some defined signal threshold, e.g., some defined minimum RSRP, need only comply with the resource restrictions associated with that SSB.

At least one embodiment includes dynamic updating of the radar allocations for the respective beam coverage areas 26, such that the allocations are dynamic to allow for flexible balancing between communication needs and radar sensing needs. The SIBs carrying restriction signaling 40 for the respective beam coverage areas therefore update in terms of the restriction information they convey, to reflect changed allocations. One approach to reducing signaling overhead associated with indicating allocation changes relies on a SIB flag. When the flag of the SIB indicates a change (the change in the SIB could be indicated via a system information update or a separate flag) in the radar resources or if the grant time expires, a UE 12 can read the next SIB to know the allowed radar resources in the corresponding beam direction. A radio network node 22 may transmit the entire SIB info (related to all SSB beam directions) or a subset of SIB info (related to the closet neighbor SSB beam directions) from each SSB beam direction.

With respect to using a flag to indicate the change in the SIB, in a typical network implementation, indications of updates to the system information may be sent as a part of the paging framework. SIBs are transmitted regularly, e.g., every 80 milliseconds, but the contents typically remain constant between system information updates. This low update rate yields a low overhead for the network. When updates involve only radar resource information, UEs that do not perform radar sensing need not acquire the updated information, and a flag may be used to indicate that only radar-related resources are changed. The network can dedicate a flag for such purposes in the SI update message to indicate that the system information is updated only with respect to radar allocations. Alternatively, a separate control channel is used to indicate changes in the radar-related content of the SIB, thus triggering only UEs 12 interested in radar operation to read the updated SIB.

Alternatively, the radar-related info in the SIB may change more frequently without a SI update message being broadcasted. UEs 12 interested in performing radar operations using communication resources of the network 10 may regularly, or shortly ahead of their planned radar usage, read the SIB and confirm/update the available resource info. Here, and elsewhere, references to “the SIB” shall be understood as referring to any given instance of SIB transmission by a radio network node 10, for conveying the restriction signaling 40 applicable to any given beam coverage area or areas 26.

Radar allocations may have a validity duration or grant window. The network 10 in one or more embodiments embeds a validity duration, or a validity period, of the allocated radar resources in the SIB and a UE 12 interested in performing radar operations reads the new, potentially updated SIB slightly before the validity time of the present allocated resource expires. That is, if a UE 12 receives a SIB indicating a validity duration, the UE 12 may not attempt to receive the SIB again until just before the expiration of that validity duration. Of course, such operation may be predicated on the movement or non-movement of the UE 12 during the validity duration, e.g., whether or at what rate the UE 12 is moving. The network 10 can adjust the validity period(s) for respective beam coverage areas 26 based on the following factors: (1) resource needs for radar sensing and communications in each beam direction, which may include estimating the usage of radar resources; (2) locations of UEs that are performing radar sensing or have reported radar sensing capability, along with the locations of communications-only UEs in each beam direction; and (3) historical data or radar-usage information among neighboring radio network nodes 22.

The validity period value may be part of the dynamically changed SIB information, i.e., applying only to the current instant. The validity duration value may be counted down in the SIB as the current radar resource allocation approaches its expiration; this way, any UE 12 reading the SIB at an arbitrary time instant can obtain the current remaining value. Alternatively, the validity period may be more statically configured, essentially allowing each radio network node 22 to operate with periodic resource allocation updates and allowing individual UEs 12 to track at a regular schedule. Alternatively, if a UE 12 receives a change flag, e.g., indicating the end of a validity period, it can read the next SIB instead of requesting a new SIB.

Regarding the management of radar operations and communications in the context of avoiding interference, a UE 12 that is going to perform radar sensing using communication resources of the network 10 may perform a listen-before-talk (LBT) operation before transmitting its radar signal. For example, in at least one embodiment, a UE 12 determines allocated radar resources from restriction signaling 40 carried in a corresponding SIB received by the UE 12, and the UE 12 selects particular radar resources to use for transmitting a radar signal. Before transmitting, the UE 12 checks for current radar or other signal transmission on the particular resources. Checking according to one embodiment comprises the UE 12 performing energy detection for the particular resources. For example, if the particular resources are certain resource elements that repeat according to a defined slot/subframe/frame structure, the UE 12 evaluates those resources for some duration in advance of using them. If the UE 12 detects the particular resources as busy (in use), it may apply a backoff time before performing its next LBT check. Backoff times are randomized, for example.

Regarding time/frequency separation of radar resources, one or more embodiments use Time Division Multiplexing (TDM) to separate resources for different UEs 12. TDM may be preferred over Frequency Division Multiplexing (FDM), because FDM can cause inter-carrier interference and requires frequency-domain filtering band emission. Further, radar sensing benefits from having a wide bandwidth available for the radar signal, with the wider bandwidth increasing radar resolution. The reserved resources in terms of duration and period relate in one or more embodiments to a relative SFN timing or an absolute common timing reference (like Global Positioning System (GPS) time) or a combination.

A UE 12 can derive such timing locally from, e.g., received timing reference signals (PSS/SSS for symbol-and slot-level timing), from SIB16/SIB9 timing information (frame-level timing) or from a UE internal Global Navigation Satellite System (GNSS) receiver. Timings defined at the BS (SFN and SIB16/9) require RF propagation delay compensation for accurate local UE timing at least for above certain propagation distances, this can be accomplished using the existing Timing Advance mechanism (or enhanced versions) or other forms of RF propagation delay methods. Because of radiofrequency (RF) propagation delays, the radar transmission within a reserved time window needs to end prior to the end of the window, to not fall outside of the window at the radio network node(s) 22 within range of the radar transmission. If the network 10 is configured such that each radio network node 22 transmits the list of all associated SSBs and corresponding resources through the SIB of each SSB beam direction, a UE 12 receiving the SIB in one beam direction learns not only the radar resources allocated for that beam direction but also that of the other beam directions. Hence, if the UE 12 moves into the coverage of another beam, it already knows the allowed radar resources for the involved beam area. However, the UE 12 may need to connect to the network 10 to request the SIB (e.g., using rRACH) in the following situations:
if the SIB transmissions by the network 10 for each SSB beam provide allocation information only for that SSB beam, a UE 12 moving into a new SSB beam area needs to request the SIB for that SSB beam area;
in some situations, a UE 12 receives a SIB from a SSB beam direction but cannot decode it; in this case, the UE 12 probably has a good signal quality from another beam direction and can request the SIB info (e.g., by connecting to the network 10 and receiving dedicated RRC signaling) related to the SSB beam direction with the undecodable SIB and use those resources for the radar sensing; and
the radar SIB can be defined as a SIB that can be requested in a dedicated manner; thus, if not in connected mode, a UE 12 may enter connected mode to request the SIB. Note that as the number of UEs requesting the SIB in a specific beam direction increases, the network load also increases and the network 10 may be configured to switch to broadcasting the full SIB info in all SSB directions if the number of SIB on-demand requests overloads the network.

Although a given radio network node 22 allows radar sensing within a specific beam direction using correspondingly allocated communication resources, a UE 12 performing radar sensing for that beam direction using such resources may still interfere with other radio network nodes 22. To avoid causing such interference, the UE 12 can receive the SIB of the neighbor cells and/or listen to their SSBs to determine the allocated resources of the adjacent cells. If the potential radar sensing direction of the UE 12 is not toward the uplink of other radio network nodes 22 or the involved resources do not overlap those of the adjacent coverage areas of the network, e.g., cell(s), the radar signal can be transmitted by the UE 12 without risk of interference. That is, in beam directions where no SSB is received, the UE 12 can transmit radar signals during times allocated for uplink transmission in the network 10 without any explicit grant, using the SIB-indicated radar allocations. But regular listening and tracking is necessary since channel conditions can change in conjunction with movements of the UE 12 or its surroundings. In addition, in at least one embodiment, a radio network node 22 that is aware of a UE 12 performing radar sensing within one of the beam coverage areas 26 associated with the radio network node 22 sends notification signaling, e.g., identifying the UE 12, to a neighboring radio network node 22 in response to determining that the UE 12 is moving towards a beam coverage area 26 that is associated with the neighboring radio network node 22.

As a complement to above methods, the network 10 in one or more embodiments uses the regular mechanisms for 5G communication scheduling to schedule radar resources. Requests from the UEs 12 on dedicated radar resources (beyond what is provided as resources according to the SIB or similar) can be part of a mechanism implemented in each radio network node 22 to assess whether the amount of radar resources is sufficient or the amount of non-UE-specific radar resources should be changed.

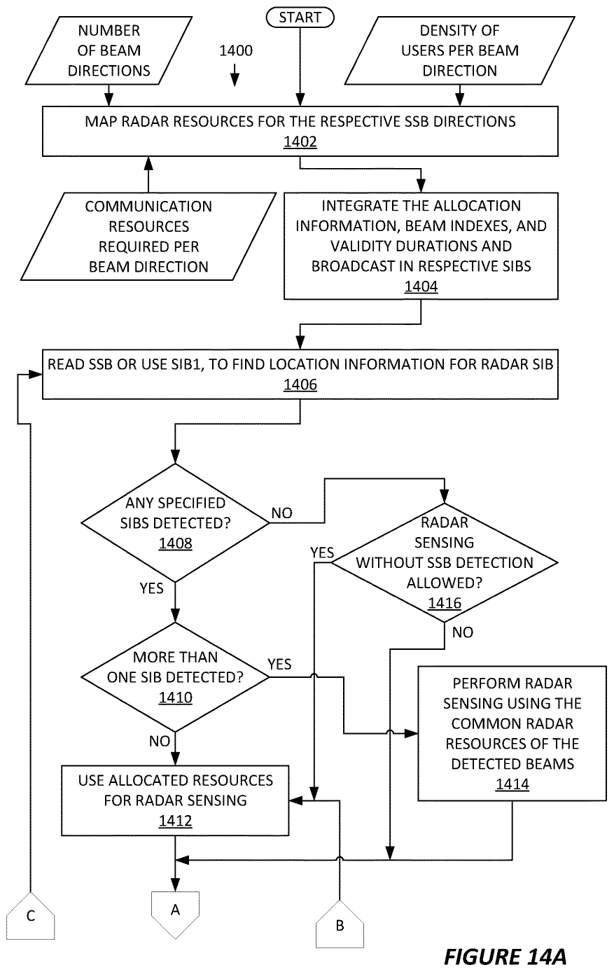

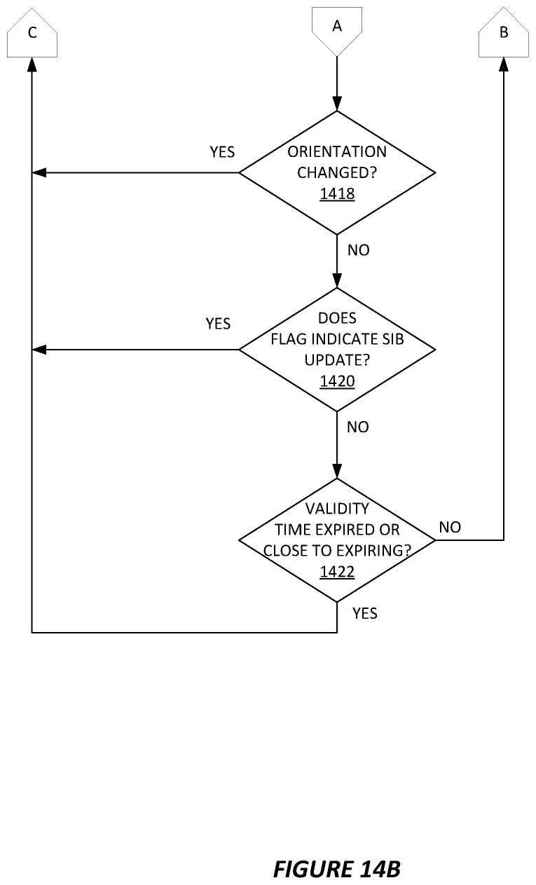

With all the above embodiments and corresponding example details in mind, FIGS. 14A and 14B illustrate a method 1400 involving network-side operations at a radio network node 22 and at a UE 12 that is in network coverage of the radio network node 22—i.e., the position of the UE 12 is at a point that is within at least one beam coverage area 26 associated with the radio network node 22. In this example, the beam coverage areas 26 are SSB areas, with the radio network node 22 transmitting respective SSBs in the different SSB directions that correspond to or otherwise define the SSB areas. The method 1400 may be performed on an ongoing basis, e.g., repeated or looped.

Block 1402 includes the radio network node 22 mapping radar resources for the respective SSB directions, based on considering several variables, such as the overall number of SSB directions, the density of users per SSB direction, and the communication resources required per SSB direction. Here, the “density of users” per beam direction comprises the number of UEs 12 known to the radio network node 22 for each beam direction. A UE 12 is known based on having an active connection, for example, or based on having been last connected to the network 10 from within one of the SSB areas. The radio network node 22 may count UEs 12 that have indicated radar capability or are known to be performing radar sensing and may count UEs 12 that are additionally or alternatively using communication services, to determine an appropriate balance for dividing the communication resources available for use in each SSB area into one allocation for communications and another allocation for radar sensing.

Block 1404 includes the radio network node integrating the allocation information, beam indexes, and allocation validity durations, if used, into signaling for transmission in the respective SSB areas. These operations can be understood as constituting or including the generation of restriction signaling 40 to be transmitted by the radio network node 22 in each SSB direction and the corresponding broadcasting of such information in respective SIBs in the different SSB directions. Here, “broadcasting” refers to the radio network node 22 performing a transmission that is not specific to any one UE 12 or group of UEs 12, but rather is transmitted for general reception by any UE 12 within the SSB area.

Block 1406 refers to operations undertaken at a UE 12 that hears at least one of the SSBs transmitted by the radio network node 22 and uses a received SSB or a SIB1 transmitted in association with the received SSB to find the location information for the SIB that carries the restriction signaling 40. As noted before, the SIB carrying the restriction signaling 40 may be referred to as a radar SIB, for convenience. The location information comprises, for example, an identification of the time-frequency resources used for transmitting the radar SIB. Different SSB areas may use different time-frequency resources for radar SIB transmission.

Block 1408 involves the UE 12 determining whether any specified SIBs are detected. Here, “specified” refers to the radar SIB(s) identified by the SSB(s) or SIB1(s) received by the UE 12. If at least one specified SIB is received (YES from Block 1408), the UE 12 in Block 1410 determines whether more than one specified SIB has been received. If not—NO from Block 1410—processing continues with the UE 12 using the resources allocated for radar sensing (Block 1412). Here, “the resources” refers to the communication resources indicated in the received SIB as being available for radar sensing use.

If no specified SIBs are received—NO from Block 1408—processing continues with the UE 12 assessing whether radar sensing without SSB detection is allowed (Block 1416). The network 10 may transmit signaling indicating whether such operation is allowed. If such operation is permitted by the network 10, processing continues—YES from Block 1416—with the operations of Block 1412. For example, the UE 12 relies on previously received allocation information. If radar sensing absent the ability to currently detect any SSBs is not allowed—NO from Block 1416—processing continues with reference to the off-page connector A.

Note that if the UE 12 detects more than one specified SIB—YES from Block 1410—processing continues with the operations of Block 1414, where the UE 12 performs radar sensing using the “common” radar resources of the detected beams. That is, if the UE 12 receives the SSB for more than one SSB area and correspondingly receives radar SIBs for more than one SSB area, the UE 12 identifies radar resources that are common to the SSB areas and performs radar sensing using those common resources, at least with respect to radar transmissions performed by the UE 12 in the transmission direction reciprocal to the listening direction by which the multiple SSBs/SIBs were received.

FIG. 14B continues with the processing flow via the off-page connector A. At Block 1418, the UE 12 evaluates whether its orientation has changed. Evaluating orientation changes reflects the fact that the transmission direction of the UE 12 in absolute or world coordinates changes as the orientation of the UE 12 changes. The UE 12 includes an Inertial Measurement Unit (IMU) with one or more accelerometers or other motion sensors to detect its current orientation or changes in orientation, for example.

If the orientation has changed, or changed by more than a threshold amount, e.g., measured in terms of angular rotation along one or more defined axes, processing returns to Block 1406 in FIG. 14A, wherein the UE 12 attempts to read SSB(s) being transmitted by the radio network node 22—see the off-page connector C. If the orientation has not changed or has not changed by more than the threshold amount, processing continues to Block 1420, with the UE 12 determining whether a flag transmitted by the radio network node 22 indicates an SIB update. As noted before, when the radar allocations for one or more of the SSB areas of the radio network node 22 change, the radio network node 22 may set a flag in the Master Information Block (MIB) or in other system-information signaling, as a trigger for prompting UEs 12 to reacquire the radar SIB(s) to obtain the changed allocation information. If the flag indicates a SIB update, processing returns to Block 1406, and otherwise continues with the UE 12 determining (Block 1422) whether the validity time for the previously identified resources (see Block 1412 or Block 1414) has expired or is about to expire. If so, processing returns to Block 1406 and, if not, processing returns to Block 1412—see the off-page connector B.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-36. (canceled)

37. A method of operation by a User Equipment (UE) configured for operation with a wireless communication network, the method comprising:
directionally listening for restriction signaling, wherein each of one or more radio network nodes transmits restriction signaling in a corresponding transmit beam direction for each of one or more beam coverage areas associated with the radio network node, and wherein the restriction signaling transmitted for each beam coverage area indicates which communication resources of the wireless communication network are allowed for radar sensing use by UEs with respect to the beam coverage area;
receiving restriction signaling in a particular listening direction, the received restriction signaling transmitted by a particular radio network node for a particular beam coverage area; and
complying with the received restriction signaling with respect to radar sensing by the UE in a transmission direction reciprocal to the particular listening direction;
wherein, for each beam coverage area, the associated radio network node transmits a System Information Block (SIB) that conveys the restriction signaling, and wherein the receiving step comprises the UE receiving and successfully decoding the SIB transmitted by the particular radio network node for the particular beam coverage area.

38. The method according to claim 37, wherein the particular listening direction is defined by a directional reception sensitivity of the UE arising from reception beamforming by the UE.

39. The method according to claim 37, wherein the UE has multiple antenna assemblies, each having a corresponding directionality relative to a current orientation of the UE, and wherein the particular listening direction is defined by the particular antenna assembly associated with the received restriction signaling.

40. The method according to claim 37, wherein complying with the received restriction signaling comprises selecting only allowed communication resources for radar sensing by the UE in the reciprocal transmission direction.

41. The method according to claim 37, wherein the restriction signaling transmitted for each beam coverage area includes first restriction signaling indicating the allowed communication resources for the beam coverage area, and further includes second restriction signaling indicating the allowed communication resources for each of one or more neighboring beam coverage areas, and wherein the method further comprises the UE deciding whether to comply with the second restriction signaling received for each neighboring beam coverage area, in dependence on whether, with respect to the particular listening direction, the UE receives a Synchronization Signal Block (SSB) or other reference signal transmission for the neighboring beam coverage area at or above a threshold received signal level.

42. The method according to claim 37, wherein the received restriction signaling comprises a System Information Block (SIB) that is received and successfully decoded by the UE, the SIB transmitted by the particular radio network node for the particular beam coverage area, and wherein the SIB indicates further restriction information for each of one or more beam coverage areas neighboring to the particular beam coverage area, and wherein the method further comprises, with respect to the reciprocal transmission direction, the UE complying with the further restrictions for each such neighboring beam coverage area in dependence on whether, with respect to the particular listening direction, the UE receives a reference signal transmitted for the neighboring beam coverage area at or above a threshold received signal level.

43. A method of operation by a radio network node of a wireless communication network, the method comprising:
generating restriction signaling for each of one or more beam coverage areas associated with the radio network node, the restriction signaling corresponding to each beam coverage area indicating which communication resources of the wireless communication network are allowed for radar sensing use by User Equipments (UEs) with respect to the beam coverage area; and
transmitting the restriction signaling for each beam coverage area via a transmit beam corresponding to the beam coverage area;
wherein the step of transmitting the restriction signaling for each beam coverage area comprises transmitting, for each beam coverage area, a corresponding System Information Block (SIB) that includes the restriction signaling.

44. The method according to claim 43, wherein the step of transmitting the restriction signaling for each beam coverage area comprises repeatedly transmitting the restriction signaling for each one of the one or more beam coverage areas.

45. The method according to claim wherein the one or more beam coverage areas comprises a plurality of beam coverage areas illuminated by the radio network node via transmit-beam sweeping, and wherein the step of repeatedly transmitting the restriction signaling for each beam coverage area comprises transmitting the restriction signaling for each beam coverage area in each beam sweep.

46. The method according to claim 43, wherein the step of generating the restriction signaling comprises, with respect to a particular instance of transmitting the restriction signaling for a particular one of the one or more beam coverage areas, generating the restriction signaling based on a resource allocation corresponding to the particular beam coverage area.

47. The method according to claim 43, wherein the restriction signaling included in each SIB comprises first restriction signaling applicable to the corresponding beam coverage area, and second restriction signaling for each of one or more neighboring beam coverage areas.

48. The method according to claim 43, further comprising transmitting a Synchronization Signal Block (SSB) for each beam coverage area, wherein the SSB for each beam coverage area indicates a beam index corresponding to the beam coverage area and indicates at least one further beam index corresponding to the at least one neighboring beam coverage area.

49. A User Equipment (UE) configured for operation with a wireless communication network, wherein the UE comprises:
communication interface circuitry; and
processing circuitry configured to:
directionally listen for restriction signaling via the communication interface circuitry, wherein each of one or more radio network nodes transmits restriction signaling in a corresponding transmit beam direction for each of one or more beam coverage areas associated with the radio network node, and wherein the restriction signaling transmitted for each beam coverage area indicates which communication resources of the wireless communication network are allowed for radar sensing use by UEs with respect to the beam coverage area;
receive restriction signaling in a particular listening direction via the communication interface circuitry, the received restriction signaling transmitted by a particular radio network node for a particular beam coverage area; and
comply with the received restriction signaling with respect to radar sensing by the UE in a transmission direction reciprocal to the particular listening direction;
wherein, for each beam coverage area, the associated radio network node transmits a System Information Block (SIB) that conveys the restriction signaling, and
wherein the restriction signaling received in the particular listening direction is based on the UE receiving and successfully decoding the SIB transmitted by the particular radio network node for the particular beam coverage area.

50. A radio network node configured for operation in a wireless communication network, wherein the radio network node comprises:
communication interface circuitry; and
processing circuitry configured to:
generate restriction signaling for each of one or more beam coverage areas associated with the radio network node, the restriction signaling corresponding to each beam coverage area indicating which communication resources of the wireless communication network are allowed for radar sensing use by User Equipments (UEs) with respect to the beam coverage area; and
transmit, via the communication interface circuitry, the restriction signaling for each beam coverage area via a transmit beam corresponding to the beam coverage area;
wherein the step of transmitting the restriction signaling for each beam coverage area comprises transmitting, for each beam coverage area, a corresponding System Information Block (SIB) that includes the restriction signaling.

51. The radio network node of claim 50, wherein the radio network node is a base station.
